(19) United States
(12) Patent Application Publication
(10) Pub. No.: US 2007/0204008 A1
(43) Pub. Date: Aug. 30, 2007

(54) Methods and systems for content definition sharing

(76) Inventor: Christopher Sindoni, San Francisco, CA (US)

Correspondence Address: PERKINS COIE LLP, P.O. BOX 2168, MENLO PARK, CA, 94026, US

(21) Appl. No.: 11/784,391

(22) Filed: Apr. 5, 2007

Related U.S. Application Data
(63) Continuation-in-part of application No. 11/669,111, filed on Jan. 30, 2007.
(60) Provisional application No. 60/765,228, filed on Feb. 3, 2006.

(51) Int. Cl. G06F 15/16

(52) U.S. Cl. 709/217

(57) ABSTRACT

A system comprises a content originator, a content sharing device, and a content receiver. The content originator (e.g., one or more of a personal computer, a mobile telephone, a PDA, or other computing device) allows a user to generate content using a plurality of content components stored locally. A content definition, describing characteristics of the plurality of content components and manipulations used to transform the plurality of content components to the content to be shared, is generated and is sent to the content sharing device. The content sharing device (e.g., a server operated by a commercial service provider or a mobile telephone service provider) stores a plurality of content definitions that can be accessed by the content receiver. The content receiver (e.g., one or more of a personal computer, a mobile telephone, a PDA, or other computing device) can download the content definition and recreate the content.

### CLAIM OF PRIORITY

This application is a continuation-in part of co-pending U.S. Utility patent application Ser. No. 11/669,111, filed Jan. 30, 2007, entitled “METHODS AND SYSTEMS FOR RINGTONE SHARING” by Christopher Sindoni, which claims priority to U.S. Provisional Patent Application No. 60/765,228, filed Feb. 3, 2006, entitled “METHODS AND SYSTEMS FOR RINGTONE SHARING” by Christopher Sindoni, the contents of which are incorporated herein by reference.

### FIELD OF THE INVENTION

The present invention relates generally to content sharing, and more specifically, to sharing content definitions used for generating shared content without sharing the actual content files.

### BACKGROUND

With the popularity of broadband internet and wireless communications, digital contents are increasingly available online and shared among users via various computing and communication devices over a network. Here, the digital contents to be shared include but are not limited to, text files, images, audio/video clips, songs, ringtones, and any other multimedia content distributable in digital format. The computing and communication devices can be any of PDAs, cellular phones, desktop/laptop computers, and mobile/handheld/wireless devices.

Typically, the contents to be shared by a third-party provider are turnkey files created by the provider using one or more licensed content components. Such license allows the third-party to resell, distribute, and/or make derivative works of the copyrighted content components. The third party provider can edit, splice, blend, and apply other edits to the copyrighted content components to create their own derivative work using, for a non-limiting example, audio/video editing software on a personal computer. The resulting content can then be shared with other users through a network which can be but is not limited to, internet, SMS (Short Message Server), WAP (Wireless Access Protocol) push, MMS (Multimedia Message Server), a telephone network, a communication network, and the like. For a non-limiting example, responsive to an incoming telephone call, a mobile telephone can play a ringtone, such as a clip of a popular song, rather than traditional ringing sounds. Such ringtone may be provided by a third-party provider who created and distributed over the communication network to be subsequently downloaded by the user of the mobile telephone.

Users that desire a variety of content, however, can incur significant expenses by relying on the third-party provider, which in turn needs to recoup licensing fees. A user who has already licensed the content source through, for a non-limiting example, a CD/DVD purchase, effectively pays an additional licensing fee for the same content. On the other hand, users risk running afoul of copyright laws by sharing content without a license. Moreover, manual generation of content can be burdensome for some users and too complex for others.

Accordingly, a need exists for recreating shared content among devices (e.g., mobile phones) independently from the original content used to generate it.

### SUMMARY

The present invention addresses the above needs by providing systems and methods for sharing content definitions. In one embodiment, a system comprises a content originator, a content sharing device, and a content receiver. The content originator, which can be but is not limited to, one or more of a personal computer, a mobile telephone, and a PDA, or other computing/communication device, allows a content provider to generate a content to be shared using content component(s) stored locally, wherein each of the content component can be one of a text file, an image, an audio/video clip, a song, a ringtone, and any other multimedia content distributable in digital format. A content definition, describing characteristics of the shared content and manipulations (or edits) used (e.g., by a DJ) to composite it from the content component(s), is generated and sent to the content sharing device. The content sharing device (e.g., a server operated by a commercial service provider or a mobile telephone service provider) stores a plurality of content definitions that can be downloaded by the content receiver. The content receiver, which can be but is not limited to, one or more of a personal computer, a mobile telephone, a PDA, or other computing/communication device, can submit queries to search the content sharing device by, for non-limiting examples, artist name, content originator (content author), keyword(s), title, and the like. To recreate the content to be shared, the content receiver uses the content definition to identify local instances of one or more content components used to create the shared content and subsequently applies the edits associated with the content definition to these local instances of content components.

Advantageously, a shared content can be easily recreated without running afoul of copyright laws. In addition, a desirable content created by one user is easily accessibly to other users who also have locally stored instances of content component(s) of the shared content.

The features and advantages described in the specification are not all inclusive and, in particular, many additional features and advantages will be apparent to one of ordinary skill in the art in view of the drawings, specifications, and claims. Moreover, it should be noted that the language used in the specification has been principally selected for readability and instructional purposes and may not have been selected to delineate or circumscribe the inventive matter.

### BRIEF DESCRIPTION OF THE DRAWINGS

The teachings of the present invention can be readily understood by considering the following detailed description in conjunction with the accompanying figures. However, the embodiments and figures are illustrative rather than limiting; they provide examples of the invention.

FIG. 1 is a block diagram illustrating a system for sharing content definitions over client/server connections according to one embodiment of the present invention.

FIG. 2 is a block diagram illustrating a system for sharing content definitions over a peer-to-peer connection according to one embodiment of the present invention.

FIG. 3 is a block diagram illustrating a content originator and a content receiver sharing content definitions via a network.

FIG. 4 is a block diagram illustrating a content originator and a content receiver sharing content definitions via a content sharing device.

FIG. 5 is a block diagram illustrating a content module according to one embodiment of the present invention.

FIG. 6 is a block diagram illustrating a content sharing device according to one embodiment of the present invention.

FIG. 7 is a flow chart illustrating a method for providing content definitions according to one embodiment of the present invention.

FIG. 8 is a flow chart illustrating a method for sharing content definitions according to one embodiment of the present invention.

FIG. 9 is a flow chart illustrating a method for receiving the content definition according to one embodiment of the present invention.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments of the invention.

Systems and methods for sharing content are described. In one embodiment a content definition is shared between users without copying the shared content between users. For a non-limiting example, a mobile telephone user can search a web site for content definitions that can be used in conjunction with a popular song the user has previously purchased and stored locally (e.g., an MP3 file of the song purchased/licensed online). The user can then download the resulting content definition, recreate the shared content using the content definition and locally stored copy of the song associated with the content definition, and store the recreated content locally for signaling incoming calls.

A content definition (e.g., a data file) refers to a description (or characteristics) of one or more content components, which can one or more digital files formatted in, for non-limiting examples, MPEG, GIF, JPEG, WAV, MP3, MIDI, WMA, MP4, AAC, AIFF, and other audio/video/multimedia formats, and manipulations (or edits) applied to these content components to generate the content to be shared. The content description can include, for a non-limiting example, a title, a name, a unique identification number, a track number, a file format, a bit rate, a length, and other characteristics of the shared content. The manipulations (or edits) can include, but are not limited to, splices, ramping up, ramping down, blends, and mixes of the content components. Here, the content components refer to original source of text, image, video, audio (e.g., a full length MP3) and other multimedia files that can be copyrighted and licensed. The shared content is the result of manipulations (or edits) to the one or more content components, and can be loaded onto a content receiver, such as a mobile telephone, in order to be enjoyed by its user.

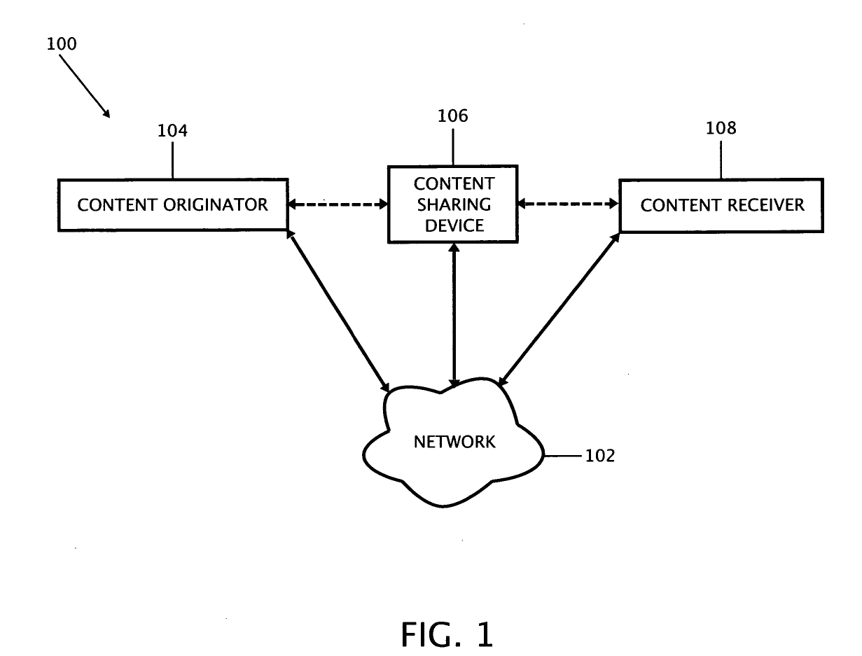

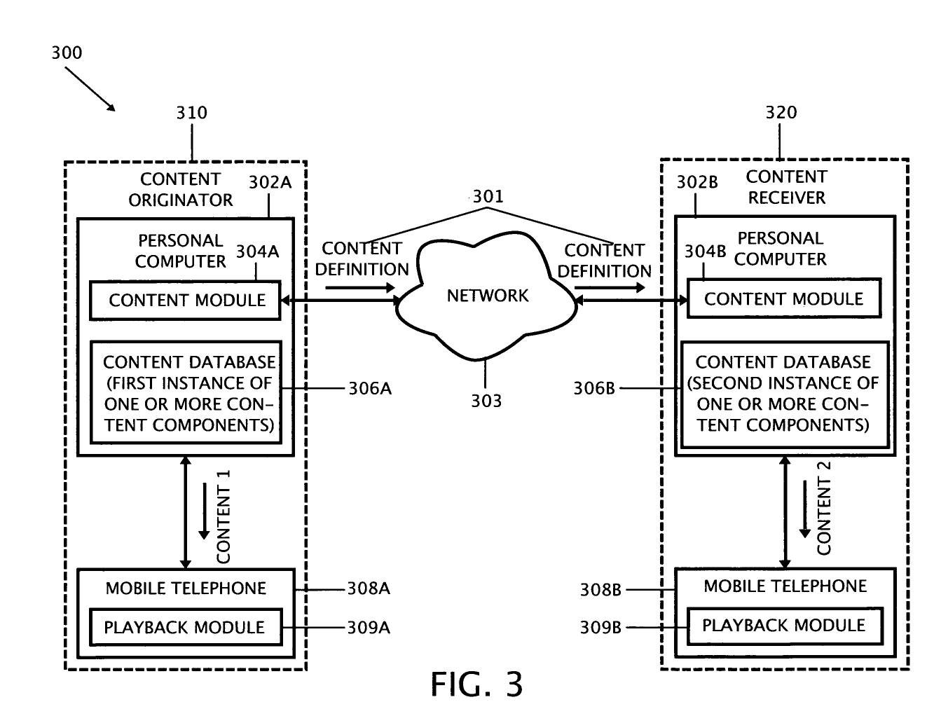

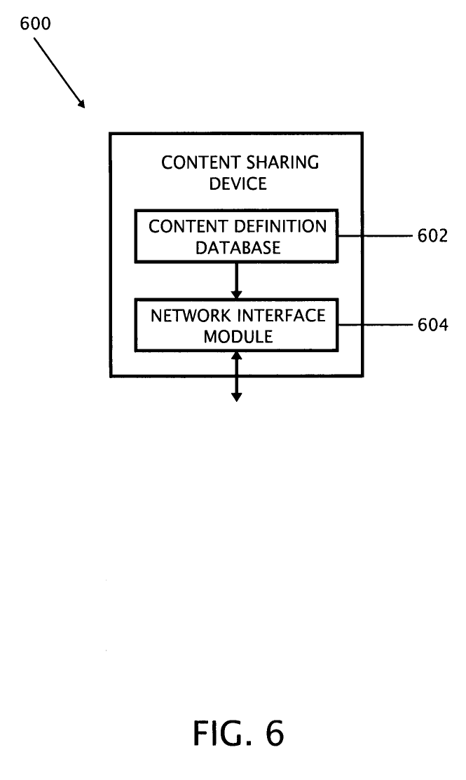

FIG. 1 is a block diagram illustrating a system 100 for sharing content definitions over client/server connections according to one embodiment of the present invention. A communication network 102 (e.g., a data network such as the Internet, or a telephone network) provides communication between a content originator 104, a content sharing device 106 and a content receiver 108. The content originator 104 (e.g., one or more of a personal computer, a mobile telephone, a PDA, or other computing device as shown in more detail in FIGS. 3-5) allows a user to generate content to be shared using one or more content components stored locally. The content originator 104 derives a content definition from the locally stored content components and edits made by a user (e.g., a DJ) to them in order to create the content to be shared, and sends the content definition to the content sharing device 106. The content sharing device 106 (e.g., a server operated by a commercial service provider or a mobile telephone service provider as shown in more detail in FIG. 6) stores a plurality of content definitions that can be accessed (e.g., downloaded) by the content receiver 108. The content receiver 108 (e.g., one or more of a personal computer, a mobile telephone, a PDA, or other computing device) can submit queries to search the content sharing device 106 by, for non-limiting examples, artist name, content originator, content title, and the like. To re-create the shared content, the content receiver 108 uses a content definition to locate local instances of one or more components of the content associated with the definition, and to apply edits associated with the content definition to the local instances of the one or more content components.

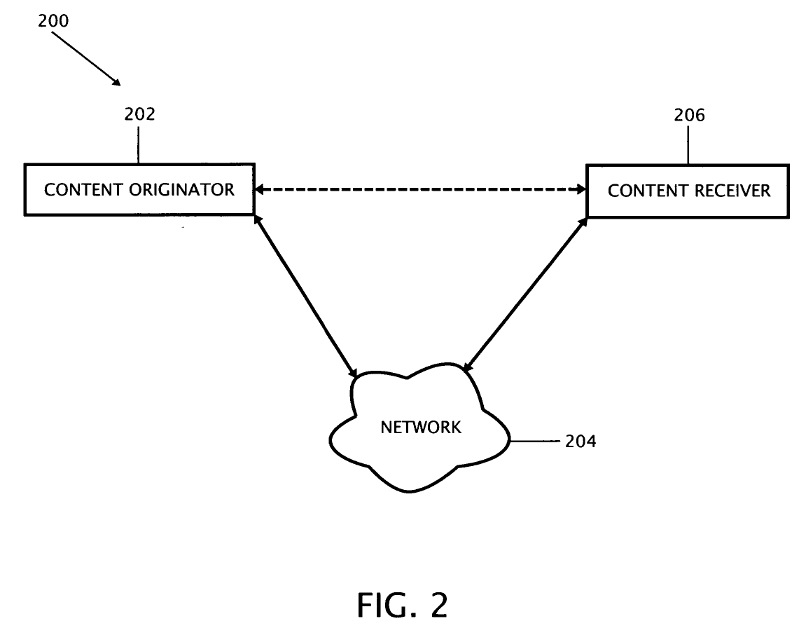

FIG. 2 is a block diagram 200 illustrating a system for sharing content definitions over a peer-to-peer connection according to one embodiment of the present invention. The content originator 202 in FIG. 2 is configured to share content definitions through a direct connection (illustrated by the dashed line) to the content receiver 206. In this embodiment, the content originator 202 and the content receiver 206 have a direct peer relationship for sharing content definitions.

FIG. 3 is a block diagram 300 illustrating a content originator and a content receiver sharing content definitions via a network. In the example of FIG. 3, a content originator 310 and content receiver 320 include personal computers 302 as well as mobile telephones 308. The personal computer 302A includes content databases 306A for storing a first instance of one or more content components. The personal computer 302A also comprises a content module 304A for generating the content to be shared and its associated content definitions. In one embodiment, the originator 310 or the content receiver 320 can be a single device (e.g., a mobile telephone). The content receiver 320 receives the content definition 301 originating from the content originator 310 via a network 303. The network 303 may be composed of any group of interconnected communication systems including a local area network (LAN), a wide area network (WAN), a telephone network, and the like. In one embodiment, the content definition 301 comprises characteristics of and edits made to the one or more content components in order to generate the corresponding content to be shared. Based on the characteristics of the content definition 301, the personal computer 302B locates a second instance of the one or more content components on the content database 306B, and the content module 304B recreates the shared content by editing the second instance of the content components according to the edits associated with the content definition 301. The personal computer 302B sends the recreated the shared content to the mobile telephone 308B and mobile telephone 308B stores the shared content in a local database or memory (not shown). The mobile telephone 308B includes a playback module 309B (e.g., a Windows® Media Player or a RealAudio® media player) to play the content.

The example in FIG. 3 is illustrative and not limiting. One ordinarily skilled in the art will understand that a system suitable to carry out the methods of the invention may include additional and/or fewer components. In one embodiment, the content originator 310 may not include a mobile telephone 308A. In another embodiment, the content databases 306 are external databases that the personal computers 304 accesses through a network such as the Internet. In one embodiment, the first and the second instance of the audio content are duplicates. In another embodiment, the first and the second instances of the content components are different versions of the same content (e.g., song) wherein there is little or no perceptive difference between the content generated from the first instance of the content components and the content recreated from the second instance of the content component(s). An exhaustive list of all combinations and permutations of embodiments has not been attempted here but one skilled in the relevant art will recognize alternative embodiments based on the system described above.

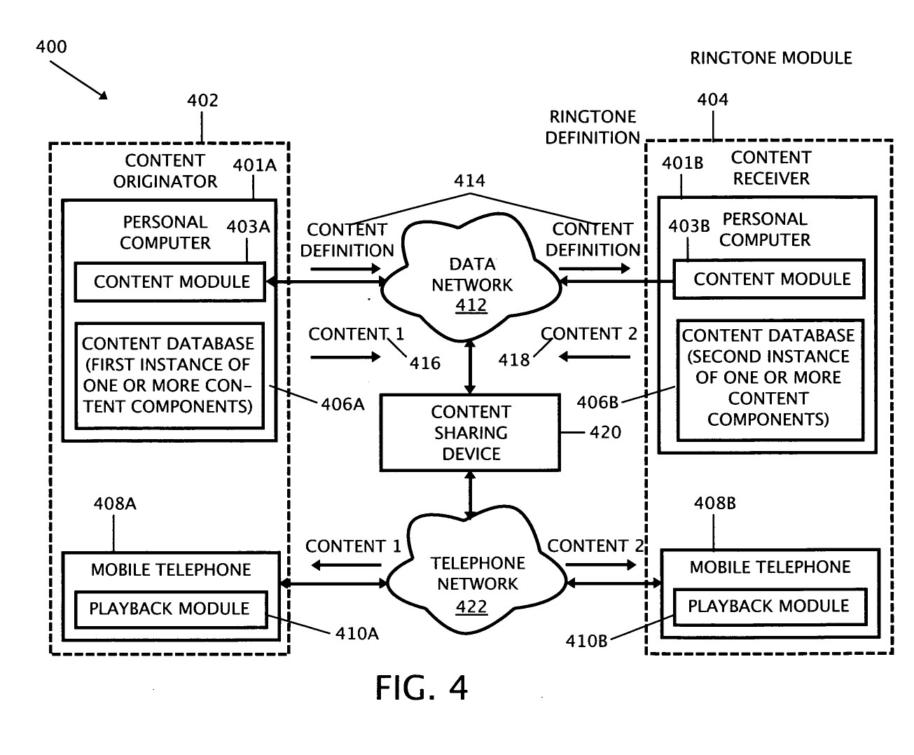

FIG. 4 is a block diagram 400 illustrating a content originator and a content receiver sharing content definitions via a content sharing device. In the example of FIG. 4, a content originator 402 and content receiver 404 include personal computers 401 as well as mobile telephones 408, respectively. The personal computers 401 are coupled to a content sharing device 420 through a data network 412 and a telephone network 422. The data network 412 may be composed of any group of interconnected communication systems including a local area network (LAN), a wide area network (WAN), a telephone network, and the like. The content sharing device 420 may be a server operated by a commercial service provider or a mobile telephone service provider. In one embodiment, the content sharing device 420 stores a plurality of content definitions from content originators such as originator 402. In one embodiment, the content sharing device 420 may be operated by a service provider who purchases content definitions from content designers/originators and subsequently provides content definition downloads to content receivers/users who subscribe to the provider's services. In another embodiment, the content sharing device 420 may be operated by a service provider that facilitates content definition sharing between shareware designers/originators and content receivers/users.

In one embodiment of the system in FIG. 4, the content module 403A creates, from one or more content components stored in the content database 406A, one or more sets of content to share and associated content definitions. The module 403A then sends the content definitions to the content sharing device 420 via the data network 412 whereby the content sharing device 420 stores the received content definitions. In one embodiment, when the content receiver 404 sends a query for a specific content identified by characteristics such as title, artist name, name, and track number, the content sharing device 420 receives the query and sends the content definition matching the query to the content receiver 404 via the data network 412. The content receiver 404 can then recreate the content with the content definition and a local instance of the content components associated with the shared content. The personal computer 403B sends the recreated content to the mobile telephone 408B for playback. Since the content receiver 404 obtains content definitions rather than content, the content receiver 404 must have a local instance of the content components associated with the shared content and therefore the receiver 404 is unlikely to violate any copyright laws by recreating the shared content with the content definition. In one embodiment, the content sharing device 420 is operated by a service provider who purchases the content definitions from content originator 402.

In one embodiment, the content receiver 404 is associated with a user who subscribes to the content sharing device 420 for a fee. The content originator 402 and/or the receiver 404 transfer the content 416 and 418 from the personal computers 403 to the mobile telephones 408 by uploading through the data network 412 and downloading through the telephone network 422.

The example in FIG. 4 is illustrative and not limiting. One ordinarily skilled in the art will understand that a system suitable to carry out the methods of the invention may include additional and/or fewer components. In one embodiment, the content originator 402 may not include a mobile telephone 408A. In another embodiment, the content databases 406 are external databases that the personal computers 401 accesses through a network such as the Internet. In yet another embodiment, the system of FIG. 4 does not include a telephone network 422 and the content originator 402 and receiver 404 only share content definitions via the data network 412 and the content sharing device 420. Moreover, the content originator 402 and receiver 404 are exemplary and it is understood by one skilled in the art that one or more content originators may create content definitions that are subsequently sent to one or more content receivers via the data network 412 and the content sharing device 420. An exhaustive list of all combinations and permutations of embodiments has not been attempted here but one skilled in the relevant art will recognize alternative embodiments based on the system described above.

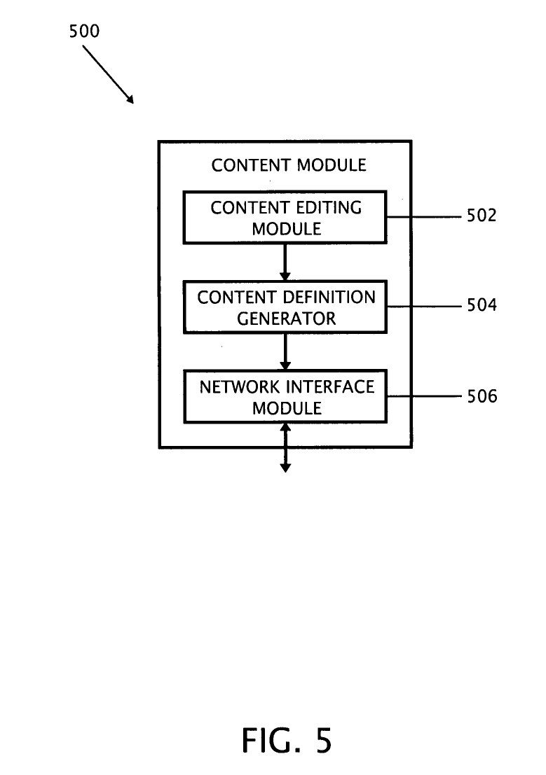

FIG. 5 is a block diagram illustrating a content module 500 according to one embodiment of the present invention. In the example of FIG. 5, the content module 500 includes a content editing module 502, a content definition generator 504, and a network interface module 506. The content editing module 502 may be an editing software that provides a timeline of one or more content components through a user interface such as a computer monitor. In one embodiment, a user utilizes the content editing module 502 to manipulate the one or more content components. The manipulations may include, but are not limited to, splices, ramp ups, ramp downs, blending, and the like. The content editing module 502 outputs the edited content by encoding a resulting file derived from the original content components and the user's interactions with the content editing module. The content editing module also outputs data describing the original content components (e.g. name, length, bit rate, etc.) and the manipulations applied to it (e.g. start frame, stop frame, fades, special effects, etc.) in order to derive the resulting content to be shared. The content definition generator 504 formats the content definition data into a format appropriate for sharing over computer networks. The resulting definition may later be used to locate other instances of the content components and convert those instances of content components to the shared content as described with reference to FIGS. 3 and 4. In another embodiment, the content definition generator 504 generates an edit list or algorithm of edits as a content definition that is later used to locate and transform local content components to shared content. In one embodiment, the content definition generator 504 generates and forwards the content definitions to the network interface module 506 for upload to a network such as those described with reference to FIGS. 3 and 4. In one embodiment, the network interface module 506 formats content and content definitions in data packets appropriate for transport across a network including, but not limited to, a LAN, a WAN, a telephone network, and the like.

FIG. 6 is a block diagram illustrating a content sharing device 600 according to one embodiment of the present invention. In the example of FIG. 6, the content sharing device 600 includes a content definition database 602 and a network interface module 604. In one embodiment, the content definition database 602 receives and stores content definitions from one or more content originators as described with reference to FIGS. 3 and 4. In another embodiment, the content definition database may be an external database or memory that the content sharing device 600 accesses via a network such as the Internet. In one embodiment, the content sharing device receives queries for content definitions via the network interface module 604 and retrieves content definitions associated with the queries from the content definition database 602. The retrieved content definitions are then uploaded, via the network interface module 604, to a network such as those described with reference to FIGS. 3 and 4. In one embodiment, the network interface module 604 formats content and content definitions in data packets appropriate for transport across a network including, but not limited to, a LAN, a WAN, a telephone network, and the like.

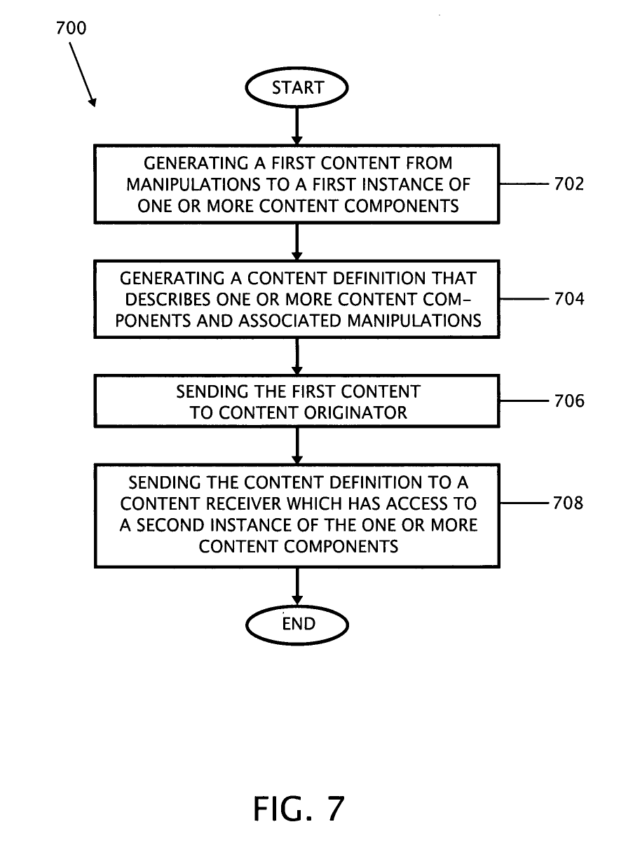

FIG. 7 is a flow chart 700 illustrating a method for providing content definitions according to one embodiment of the present invention. The example of FIG. 7 starts in module 702 where a personal computer associated with a content originator generates content by manipulating a first instance of one or more content components. The manipulations may include, but are not limited to, splices, ramp ups, ramp downs, blending, and the like. The example of FIG. 7 continues to module 704 where a content definition is generated to describe the first instance of the content components and the manipulations performed on the first instance of the content components in module 702. The example of FIG. 7 continues to module 706 where the resulting content to be shared is sent to a mobile telephone associated with the content originator. The example of FIG. 7 continues to module 708 where the content originator sends the content definition associated with the content to a content receiver that has access to a second instance of the audio content. In one embodiment, the content receiver receives the content definition, locates the second instance of the one or more content components, and recreates the shared content using the content definition and the second instance of the content components. In another embodiment, the content receiver receives the content definition, locates an instance of the content components that is substantially similar to the first instance of the content components (e.g. different versions of the same song), and recreates the content using the content definition and the instance of the content components that is substantially similar to the first instance of the content components.

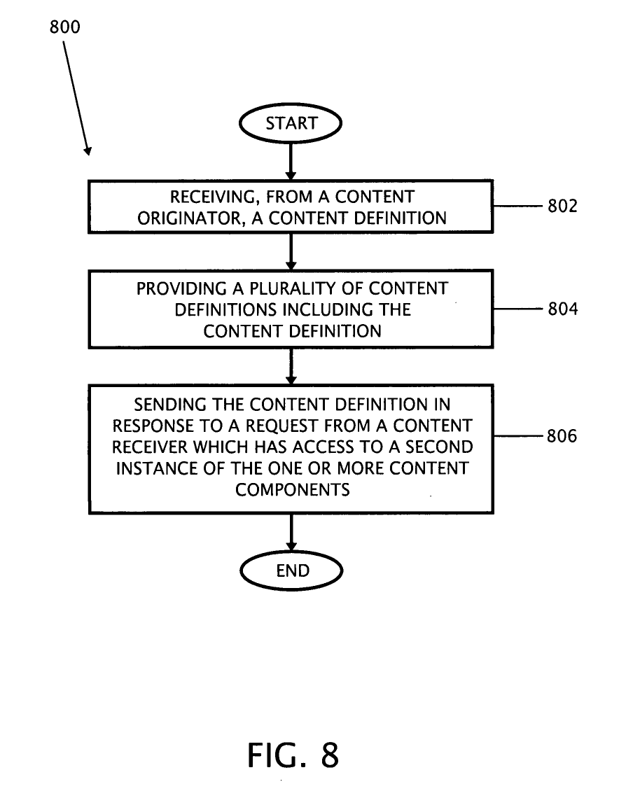

FIG. 8 is a flow chart 800 illustrating a method for sharing content definitions according to one embodiment of the present invention. The example of FIG. 8 starts in module 802 where a content sharing device receives a content definition from a content originator. The example of FIG. 8 continues to module 804 where the content sharing device receives a plurality of content definitions, including the content definition, from one or more content originators and stores the definitions so that one or more users (e.g., web site subscribers or cell phone service subscribers) may query and retrieve the content definitions. The example of FIG. 8 continues to module 806 where the content sharing device sends the content definition to a content receiver in response to a query from the content receiver. In one embodiment, the content receiver has access to a second instance of the content components associated with the content definition and recreates the shared content using the content definition and the second instance of the content components. In another embodiment, the content receiver has access to an instance of the content components that is substantially similar to the content components associated with the content definition and recreates the content using the content definition and the instance of the content components that is substantially similar (e.g. different versions of the same song) to the content components associated with the content definition.

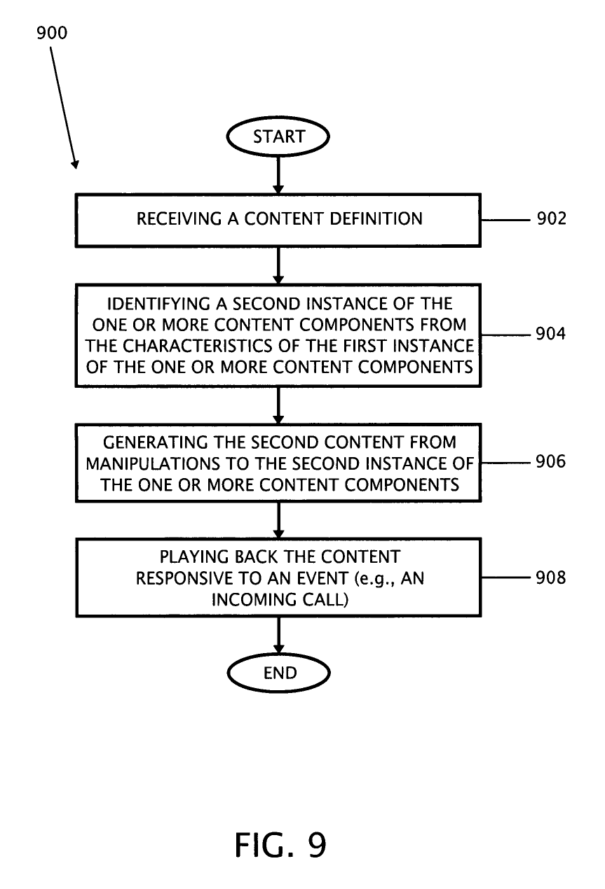

FIG. 9 is a flow chart 900 illustrating a method for receiving a content definition according to one embodiment of the present invention. The example of FIG. 9 starts in module 902 where a content receiver receives a content definition. The example of FIG. 9 continues to module 904 where the content receiver searches an associated content database for content components matching those content characteristics associated with the content definition. In one embodiment, the receiver conducts the search using tolerance metrics to account for content component(s) that are substantially similar despite variances in format, bit rate, song length, and the like. The example of FIG. 9 continues to module 906 where content is generated by applying the edits associated with the content definition to the content component(s) identified in module 904. In one embodiment where a second instance of the audio content cannot be located in module 904, a license can be automatically acquired. In another embodiment where a second instance of the content component(s) cannot be located in module 904, the content receiver may receive a notice that a license must be acquired in order to obtain the content component(s). The example of FIG. 9 continues to module 908 where a mobile telephone associated with the content receiver plays back the recreated content in response to, for a non-limiting example, an incoming call received by the mobile telephone.

The order in which the steps of the methods of the present invention are performed is purely illustrative in nature. The steps can be performed in any order or in parallel, unless otherwise indicated by the present disclosure. The methods of the present invention may be performed in hardware, firmware, software, or any combination thereof operating on a single computer or multiple computers of any type. Software embodying the present invention may comprise computer instructions in any form (e.g., source code, object code, interpreted code, etc.) stored in any computer-readable storage medium (e.g., a ROM, a RAM, a magnetic media, a compact disc, a DVD, etc.). Such software may also be in the form of an electrical data signal embodied in a carrier wave propagating on a conductive medium or in the form of light pulses that propagate through an optical fiber.

While particular embodiments of the present invention have been shown and described, it will be apparent to those skilled in the art that changes and modifications may be made without departing from this invention in its broader aspect and, therefore, the appended claims are to encompass within their scope all such changes and modifications, as fall within the true spirit of this invention. For a non-limiting example, the systems and methods of the present invention can be used to share definitions of any type of multimedia file, such as video. Additionally, content can be generated for a variety of uses such as ringbacks (i.e., content played to a caller on an outgoing call while waiting for a called party to answer), and other edited content.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus can be specially constructed for the required purposes, or it can comprise a general-purpose computer selectively activated or reconfigured by a computer program stored in the computer. Such a computer program can be stored in a computer readable storage medium, such as, but is not limited to, any type of disk including floppy disks, optical disks, CD-ROMs, and magnetic-optical disks, read-only memories (ROMs), random access memories (RAMS), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems can be used with programs in accordance with the teachings herein, or it may prove convenient to construct more specialized apparatuses to perform the method steps. The required structure for a variety of these systems will appear from the description herein. In addition, the present invention is not described with reference to any particular programming language. It will be appreciated that a variety of programming languages can be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

What is claimed is:

1. A method for content sharing, comprising:
generating a content definition, wherein the content definition comprises characteristics of and manipulations to a first instance of one or more content components;
distributing the content definition to one or more devices; and
generating the content from a second instance of the one or more content components on the one or more devices using the content definition.

2. The method of claim 1, wherein each of the one or more content components is one of: a text file, an image, an audio/video clip, a song, a ringtone, and a multimedia content distributable in digital format.

3. The method of claim 1, wherein one or more users associated with the one or more devices have licensed the one or more content components.

4. The method of claim 1, further comprising the steps of:
determining if a licensed version of the second instance of one or more content components is locally available on the one or more devices; and
obtaining the second instance of the one or more content components with a license automatically.

5. The method of claim 4, wherein the characteristics of the first instance of the one or more content components and the characteristics of the second instance of the one or more content components are substantially similar.

6. The method of claim 1, wherein the one or more devices comprises a mobile telephone.

7. The method of claim 1, wherein the content definition is received by a content sharing device operated by a content service provider.

8. The method of claim 7, wherein the content service provider distributes the content definition to a subscriber of the content service provider.

9. A method for content sharing, comprising:
generating a content by manipulating a first instance of one or more content components;
generating a content definition that describes characteristics of, and the manipulations to the first instance of the one or more content components; and
distributing the content definition to a device.

10. The method of claim 9, wherein the device has access to a second instance of the one or more content components.

11. The method of claim 9, wherein the device is a communication device.

12. A method for content sharing, comprising:
receiving a content definition that describes characteristics of, and manipulations to a first instance of one or more content components; and
generating a content by applying the manipulations associated with the content definition to a second instance of the one or more content components.

13. The method of claim 12, further comprising the step of identifying a second instance of the one or more content components using the characteristics described in the content definition.

14. The method of claim 12, further comprising the step of playing back the content in response to an event

15. The method of claim 14, wherein the event is an incoming telephone call.

16. A system for content sharing, comprising:
a content originator that generates a content definition, wherein the content definition describes characteristics of, and manipulations to a first instance of one or more content components;
a content receiver coupled to the content originator wherein the content receiver receives the content definition; and
a content module that derives content from the content definition and a second instance of the one or more content components associated with the characteristics described by the content definition.

17. The system of claim 16, further comprising a network wherein the content originator and the content receiver are coupled through the network.

18. The system of claim 17, wherein the network is one of internet, a local area network (LAN), a wide area network (WAN), a wired communication network, and a wireless communication network.

19. The system of claim 16, wherein the content originator further comprises a first content database for storing a first instance of the one or more content components.

20. The system of claim 19, wherein the content originator further comprises a first content module coupled to the first content database and wherein the first content module receives a first instance of the one or more content components from the first content database, and manipulates the first instance of the one or more content components to generate content.

21. The system of claim 16, wherein the content originator is one or more of a personal computer, a mobile telephone, a PDA, or other computing/communication device.

22. The system of claim 21, wherein the first communication device further comprises a first playback module.

23. The system of claim 16, wherein the content receiver further comprises a second content database for storing a second instance of the one or more content components.

24. The system of claim 23, wherein the content receiver further comprises a second content module coupled to the second content database and wherein the second content module receives a content definition from the content originator, queries the second content database for an instance of the one or more content components matching the characteristics of the content definition, and applies the manipulations associated with the content definition to the matching instance of the one or more content components.

25. The system of claim 16, wherein the content receiver further comprises a second communication device.

26. The system of claim 25, wherein the second communication device further comprises a second playback module.

27. A system for content sharing, comprising:
a content originator that generates content definitions, wherein the content definitions describe characteristics of, and manipulations to one or more content components;
a content sharing device coupled to the content originator wherein the content sharing device receives the content definitions from the content originator; and
a content receiver coupled to the content sharing device wherein the content receiver receives the content definitions from the content sharing device.

28. The system of claim 27, wherein the content sharing device is associated with a content service provider.

29. The system of claim 28, wherein the content receiver is associated with a user who subscribes to the content service provider.

30. The system of claim 27, further comprising a network coupled to the content originator, the content sharing device, and the content receiver.

31. The system of claim 27 wherein the content originator is a user device and the one or more content components reside on the user device.

32. A user device comprising:
a content definition;
one or more content components; and
a content generator software operable to use the content definition and the one or more content components to create a content suitable for use on a mobile telephone.

33. The user device of claim 32, further comprising:
content editing software enabling a user to generate the content definition at the user device.

34. The user device of claim 32, wherein the user device is the mobile telephone.

35. The user device of claim 32, wherein the user device is a personal computer capable of sharing the content definition with the mobile telephone.

36. The user device of claim 32, further comprising:
content sharing software for sharing the definition with other users.
